(19) United States
(12) Patent Application Publication
(10) Pub. No.: US 2013/0117062 A1
(43) Pub. Date: May 9, 2013

(54) ONLINE RESOURCE ALLOCATION ALGORITHMS

(71) Applicants: Nikhil Devanur Rangarajan, Redmond, WA (US); Kamal Jain, Bellevue, WA (US); Balasubramanian Sivan, Chennai (IN); Christopher A. Wilkens, Fremont, CA (US)

(72) Inventors: Nikhil Devanur Rangarajan, Redmond, WA (US); Kamal Jain, Bellevue, WA (US); Balasubramanian Sivan, Chennai (IN); Christopher A. Wilkens, Fremont, CA (US)

(73) Assignee: MICROSOFT CORPORATION, Redmond, WA (US)

(21) Appl. No.: 13/288,650

(22) Filed: Nov. 3, 2011

(51) Int. Cl. G06Q 10/06

(52) U.S. Cl. 705/7.25

(57) ABSTRACT

Various embodiments provide online algorithms for resource allocation. In one or more embodiments, requests for resources from a service provider are received stochastically. For each request, different options for satisfying the request are evaluated based in part upon shadow costs (e.g., unit costs) that are assigned to resources associated with the different options. One of the options may be selected by optimizing an objective function that accounts for the shadow costs. Resources for the selected option are allocated to the request and an adjustment is made to the shadow costs for remaining resources to reflect differences in rates for allocation and/or consumption of the resources. Thereafter, resources may be allocated to a subsequent request using the updated shadow costs and the costs are adjusted again. By updating shadow costs iteratively in this manner, an increasingly more accurate analysis of the objective function is achieved.

### BACKGROUND

Resource allocation problems that involve matching of resources available from a service provider to a set of requests from clients for the resources can arise in a variety of different contexts. One example resource allocation problem arises in online advertising scenarios, where advertisers may request/buy space for display ads (e.g., graphical “banner” ads) to be shown to users in conjunction with web-pages available from service providers. The service providers may be compensated an amount for each web-page impression (e.g., user view of a page) for which an advertisement is shown. Display ads are typically sold with guaranteed impression goals. In this scenario, the service provider sells orders for a fixed number of impressions and is responsible for making sure that the goals for the orders are met. In this context, the service provider may be concerned with matching of various requests to impressions in a manner that increases revenue and fulfills all the orders.

Matching for the example online advertising scenario and other comparable resource allocation problems, though, can become quite difficult as the number of requests to be matched becomes larger due to the number of computations involved in performing the matching. Traditional algorithms suitable to perform matching with relatively small data sets may be unable to successfully perform matching for larger data sets that arise in some scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide online algorithms for resource allocation. In one or more embodiments, requests for resources from a service provider are received stochastically. For each request, different options for satisfying the request are evaluated based in part upon shadow costs (e.g., unit costs) that are assigned to resources associated with the different options. One of the options may be selected by optimizing an objective function that accounts for the shadow costs. Resources for the selected option are allocated to the request and an adjustment is made to the shadow costs for remaining resources to reflect differences in rates for allocation and/or consumption of the resources. Thereafter, resources may be allocated to a subsequent request using the updated shadow costs and the costs are adjusted again. By updating shadow costs iteratively in this manner, an increasingly more accurate analysis of the objective function is achieved.

### BRIEF DESCRIPTION OF THE DRAWINGS

FIG. 1 illustrates an example operating environment in which one or more embodiments of online resource allocation algorithms can be employed.

FIG. 2 is a flow diagram that describes an example procedure in accordance with one or more embodiments.

FIG. 3 is a flow diagram that describes details of an example online resource allocation algorithm in accordance with one or more embodiments.

FIG. 4 is a flow diagram that describes details of an example objective function in accordance with one or more embodiments.

FIG. 5 is a block diagram of a system that can implement the various embodiments.

### DETAILED DESCRIPTION

Overview

Various embodiments provide online algorithms for resource allocation. In one or more embodiments, requests for resources from a service provider are received stochastically. For example, advertisers may place bids/orders for advertising space within webpages served to clients by a service provider. For each request, different options for satisfying the request are evaluated based in part upon shadow costs (e.g., unit costs) that are assigned to resources associated with the different options. In the advertising example, the resources are different impressions or instances of a webpage with an ad being displayed to a client. One of the options to satisfy the request may be selected by optimizing an objective function that accounts for the shadow costs. This may involve maximizing a profit margin computed for the different options by subtracting cost for the option (e.g., a sum of the shadow costs) from profit or revenue. Resources for the selected option are allocated to the request and an adjustment is made to the shadow costs for remaining resources to reflect differences in rates for allocation and/or consumption of the resources. Thereafter, resources may be allocated to a subsequent request using the updated shadow costs and the costs are adjusted again. By updating shadow costs iteratively in this manner, an increasingly more accurate analysis of the objective function is achieved.

In the discussion that follows, a section titled “Operating Environment” describes but one environment in which the various embodiments can be employed. Following this, a section titled “Online Resource Allocation Algorithm Procedures” describes example procedures in accordance with one or more embodiments. Next, a section titled “Online Resource Allocation Algorithm Implementation Details” describes example algorithms and implementations for resource allocation in accordance with one or more embodiments. Last, a section titled “Example System” is provided and describes an example system that can be used to implement one or more embodiments.

Operating Environment

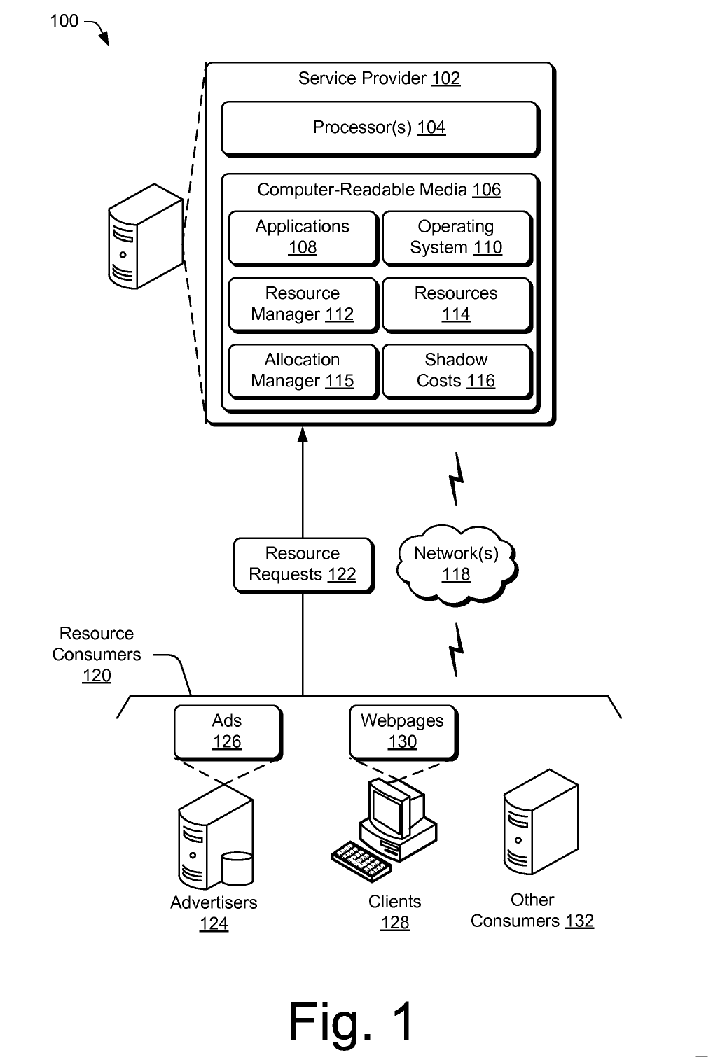

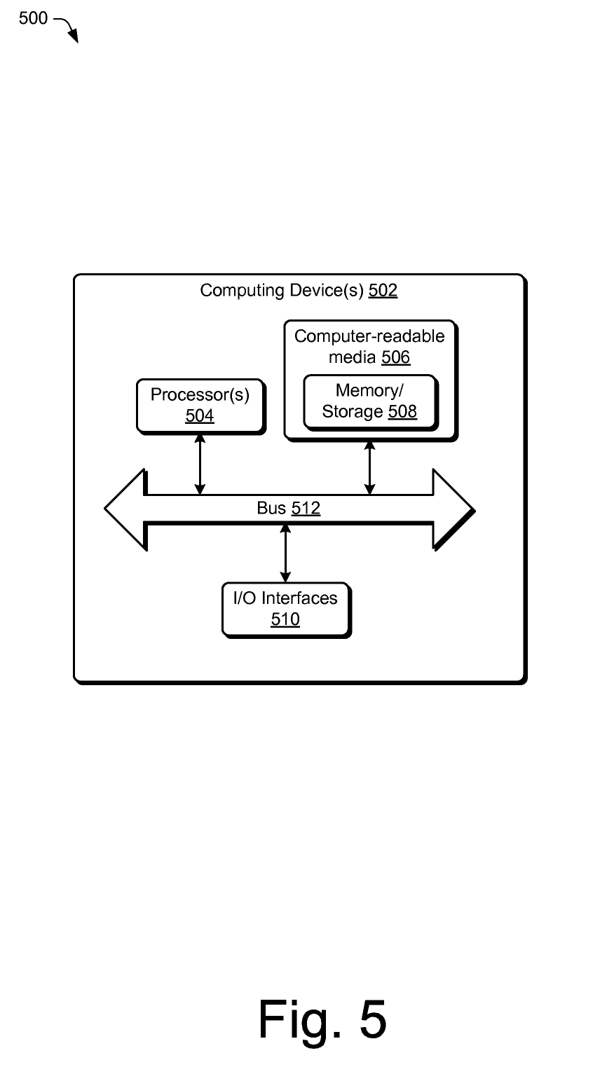

FIG. 1 illustrates an operating environment in accordance with one or more embodiments, generally at 100. The environment 100 includes a service provider 102 having one or more processors 104, one or more computer-readable media 106 and one or more applications 108 that are stored on the computer-readable media and which are executable by the one or more processors 104. The service provider 102 can be embodied as any suitable computing device or combination of devices such as, by way of example and not limitation, a server, a server farm, a peer-to-peer network of devices, a desktop computer, and the like. One example of a computing system that may represent various systems and/or devices including the service provider 102 is shown and described below in relation to FIG. 5.

The computer-readable media may include, by way of example and not limitation, forms of volatile and non-volatile memory and/or storage media that are typically associated with a computing device. Such media may include ROM, RAM, flash memory, hard disk, removable media and the like. One such configuration of a computer-readable media is signal bearing “communication media” that is configured to transmit computer-readable instructions (e.g., as a carrier wave) to the hardware of the computing device, such as via a network. The computer-readable medium may also be configured as “computer-readable storage media” that excludes mere signal transmission and/or signals per se. Thus, computer-readable media includes both “computer-readable storage media” and “communication media” further examples of which can also be found in the discussion of the example computing system of FIG. 5.

Computer-readable media 106 is also depicted as storing an operating system 110, a resource manager 112, resources 114 (e.g., content, services, and data), and an allocation manager 115 that may also be executable by the processor(s) 104. While illustrated separately, the allocation manager 115 may also be implemented as a component of the resource manager 112. Generally speaking, the resource manager 112 represents functionality operable by the service provider 102 to manage various resources 114 that may be made available over a network. The resource manager 112 may manage access to the resources 114, performance of the resources 114, configuration of user interfaces or data to provide the resources 114, and so on.

To determine how to allocate the resources 114, the resource manager 112 may include or otherwise make use of an allocation manager 115. The allocation manager 115 represents functionality to implement various online algorithms for resource allocation described herein. In at least some embodiments, the allocation manager is configured to manage and use shadow costs 116 associated with various resources 114 to evaluate resource allocation options and pick an appropriate option to service resource requests. The shadow costs 116 may be configured as computed or estimated costs that are assigned on an individual basis to different resources. In at least some embodiments the shadow costs 116 are unit costs for a designated quantity of corresponding resources 114.

Thus, the allocation manager 115 may perform various operations to ascertain optimal allocation solutions for resource requests including, but not limited to, assigning shadow costs 116 to the resources, computing profit/revenue values for multiple allocation options, picking an optimal option using an objective function, and iteratively updating the shadow costs 116 as resources are consumed to reflect different rates of consumption for different resources. These and other aspects of online resource allocation techniques are described in greater detail below in relation to the following example procedures.

As further depicted in FIG. 1, the service provider 102 can be communicatively coupled over a network 118 to various other entities (e.g., devices, servers, storage locations, clients, users, and so forth) that may interact with the service provider 102 to take advantage of resources 114 made available by the service provider 102. Although the network 118 is illustrated as the Internet, the network may assume a wide variety of configurations. For example, the network 118 may include a wide area network (WAN), a local area network (LAN), a wireless network, a public telephone network, an intranet, and so on. Further, although a single network 118 is shown, the network 118 may be configured to include multiple networks.

In particular, the service provider 102 is illustrated as being connected over the network 118 to resource consumers 120 that may submit resource requests 122 to access the resources 114. For example, resources consumers 120 may form resource requests 122 for communication to the service provider 102 to obtain corresponding resources 114. In response to receiving such requests, the service provider 102 can process the requests via the resource manager 112 and/or allocation manager 115 and provide various resources 114. Various different kinds of resource consumers 120 are contemplated, which by way of example and not limitation are depicted in FIG. 1 as including advertisers 124 that may provide advertisements 126 for placement in connection with resources 114, clients 128 that may access and make use of resources 114 through webpages 130 or otherwise, and other consumers 132 such as business entities, third-party partner sites, and the like.

Resources 114 can include any suitable combination of content and/or services typically made available over a network by one or more service providers. For instance, content can include various combinations of text, video, ads, audio, multi-media streams, animations, images, and the like. Some examples of services include, but are not limited to, online computing services (e.g., “cloud” computing), web-based applications, a file storage and collaboration service, a search service, messaging services such as email and/or instant messaging for sending messages between different entities, and a social networking service to facilitate connections and interactions between groups of users who share common interests and activities. Services may also include an advertisement service configured to enable advertisers 124 to purchase advertising space and/or place advertisements 126 for presentation to clients in conjunction with the resources 114.

Having considered an example operating environment, consider now a discussion of example online resource allocation algorithm procedures in accordance with one or more embodiments.

Online Resource Allocation Algorithm Procedures

The following discussion describes procedures involving online resource allocation algorithms that may be implemented utilizing the environment, systems, and/or devices described above and below. Aspects of each of the procedures below may be implemented in hardware, firmware, software, or a combination thereof. The following procedures are shown as a set of blocks that specify operations performed by one or more devices and are not necessarily limited to the orders shown for performing the operations by the respective blocks. In portions of the following discussion, reference may be made to the example environment 100 of FIG. 1.

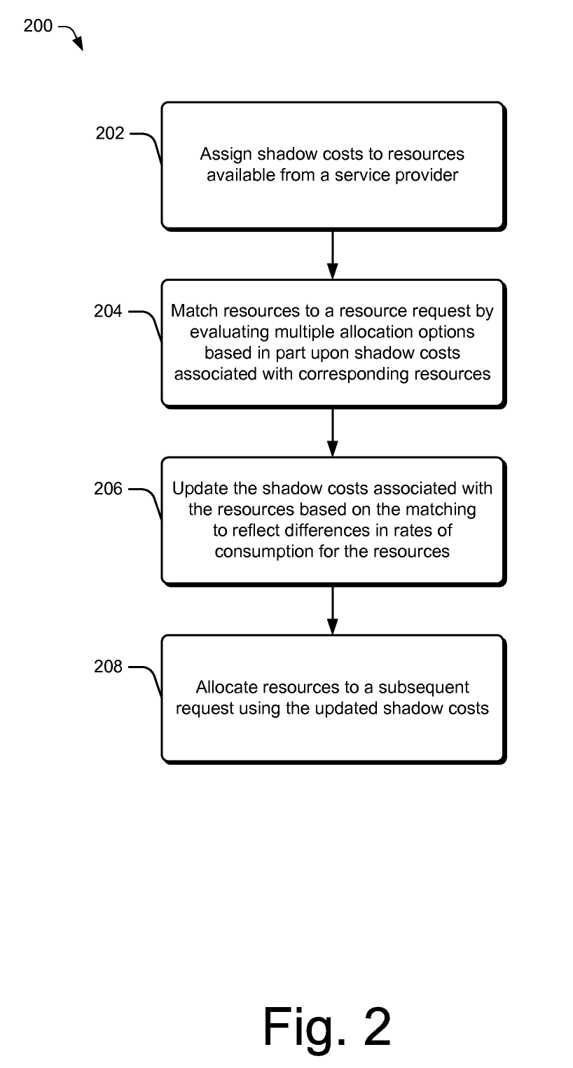

FIG. 2 is a flow diagram that describes an example procedure 200 for online resource allocation in accordance with one or more embodiments. In at least some embodiments, the procedure 200 can be performed by a suitably configured computing device, such as a service provider 102 of FIG. 1, or other computing device having an allocation manager 115 and/or resource manager 112.

Shadow costs are assigned to resources available from a service provider (block 202). For example, an allocation manager 115 may operate to ascertain and assign shadow costs 116 to resources 114 as mentioned previously. The shadow costs for a particular resource may represent unit costs (e.g. price per quantity of resource) that can be used to compute a total cost for a requested amount of the particular resource. In at least some embodiments, the shadow costs may be computed and assigned initially as an estimate. In one approach, an initial sampling of resource requests can be employed to compute an initial estimate of the shadow cost for a corresponding resource. In addition or alternatively, the initial shadow cost may also be computed offline through analysis of historical data. Combinations of the foregoing approaches are also contemplated.

Resources are matched to a resource request by evaluating multiple allocation options based in part upon shadow costs associated with corresponding resources (block 204). Here, the allocation manager 115 may operate to determine an optimal allocation solution for a particular resource request 122 using the assigned shadow costs. A given request may specify requested quantities and/or prices to be paid for one or more requested resources. The allocation manager 115 may test one or more allocation options having different combinations of available resources to find a “best option.” To do so, the allocation manager 115 applies a resource allocation algorithm that is based at least in part upon the shadow costs, some examples of which are described herein. Generally, speaking the allocation manager 115 may apply an algorithm to evaluate an objective function that encodes a computational objective (e.g., the goal) for the allocation of the resources. For example, the objective function may be configured to maximize revenue or profit that is computed using the shadow costs for different resources. By testing multiple different allocation options (e.g., combinations of available resources), the allocation manager 115 can select an appropriate option that optimizes the objective function and can match corresponding resources to the resource request. Further details regarding objective functions and resource allocation algorithms that may be employed are discussed in relation to the following figures.

Shadow costs associated with the resources are updated based on the matching to reflect differences in rates of consumption for the resources (block 206) and resources are allocated to a subsequent request using the updated shadow costs (block 208). As discussed in greater detail below, the allocation manager 115 may iteratively adjust shadow costs on an ongoing basis to obtain an increasingly more accurate value for the shadow costs. Thus, after resources are allocated to a particular request, shadow costs are adjusted to reflect rates at which different resources are being consumed. For different sources of a resource that are fungible with respect to one another, cost is generally increased for a particular source as the rate of consumption of the resource from the source is increased. Likewise, the shadow cost may be decreased for sources that are unused or under-utilized. Effectively, the shadow costs act as priority values that can be used to distribute resource allocation efficiently among various options/sources for the resources by setting the relative cost of resources one to another. As a particular resource becomes scarcer, the cost is increased and accordingly it may become more favorable to select a different resource to service a current request. On the other hand, an under-utilized resource will be associated with a relatively lower cost and therefore becomes a more attractive option to service a request. Shadow costs that are updated in the preceding manner may then be used for handling a subsequent request and the process may repeat, such that updated costs are determined and employed iteratively to allocate resources to each request that is received by a service provider 102.

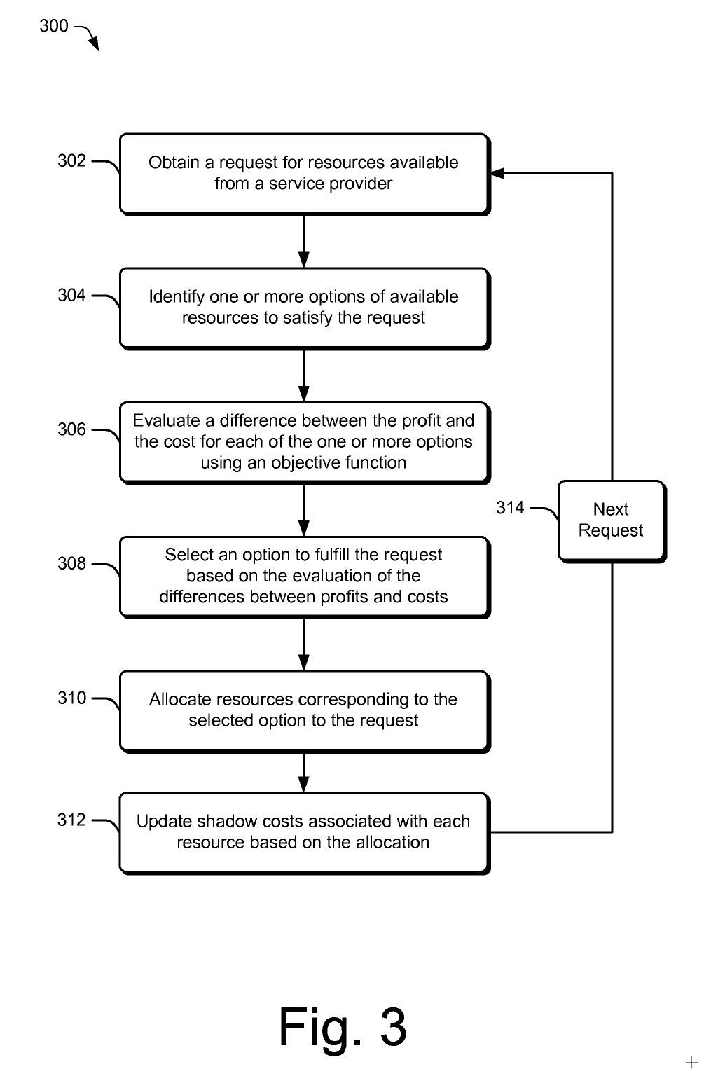

FIG. 3 is a flow diagram that describes another example procedure 300 for online resource allocation in accordance with one or more embodiments. A request for resources available from a service provider is obtained (block 302). For instance, a resource consumer 120 may submit a resource request 122 to a service provider 102. The service provider 102 may be configured to handle the request and allocate resources to the request using an allocation manager 115 and/or resource manager 112. The request may specify one or more different kinds of resources 114 and requested quantities, such as ad space (e.g. impressions), online computing resources, webpages, load balancing parameters, message routing criteria, storage or processing capacity, account access, and so forth. A request may also include or otherwise be associated with a price to be paid for the corresponding resources 114. The price reflects the value of the request to the provider, e.g., potential revenue/profit. The allocation manager 115 may operate to determine and select particular sources of requested resources such as selecting particular servers in a server farm, distribution of goods in an auction setting, webpages having ad space (e.g., available impressions), load balancing between servers, or message routing paths in different allocation scenarios, to name a few examples.

In particular, one or more options of available resources are identified to satisfy the request (block 304). For instance, given the resources and quantities specified by a request (e.g., the request constraints), the allocation manager 115 may identify one or more combinations of resources that are available to serve the request based on resource constraints such as amount of resources available, resource prices, time/date constraints, and so forth. In other words, given particular request constraints and resource constraints, the allocation manager 115 may develop one or more options to be evaluated by matching of the request constraints with resources 114 having the resource constraints, such that the request constraints and resource constraints are both satisfied.

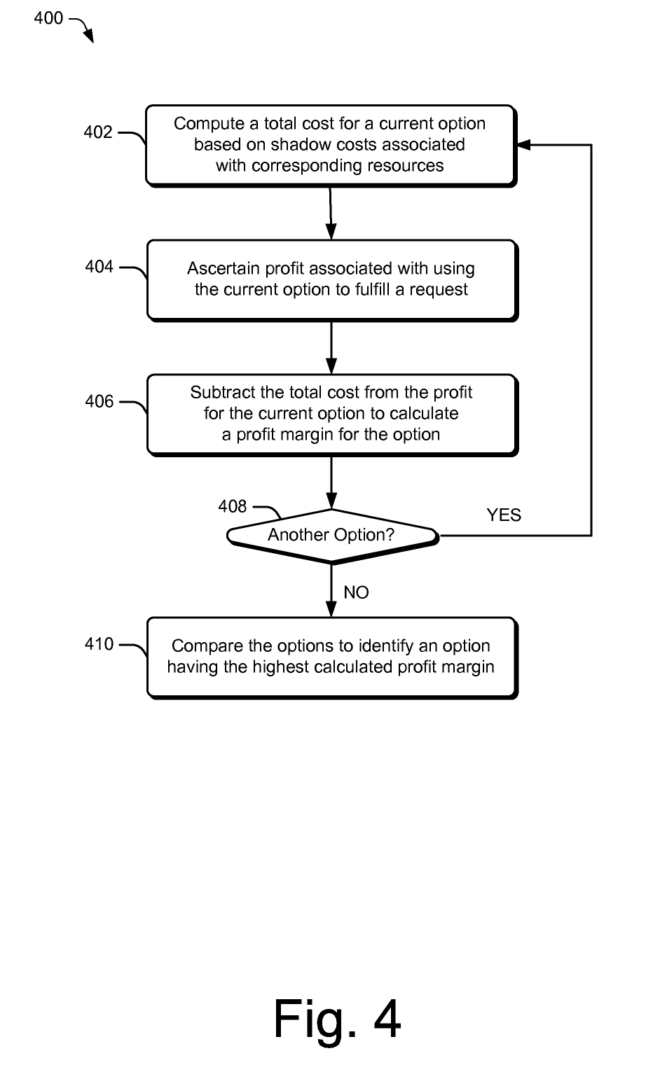

A difference is evaluated between the profit and cost for each of the one or more options using an objective function (block 306). For example, total cost for an option may be computed by summing the shadow costs time quantity for each resource involved in the option. The total cost may then be subtracted from a profit value that corresponds to the option. The profit value as used herein represents an appropriate measurement of the value of a corresponding option. The profit value may be computed in various ways such as revenue generated by the option, total price paid for the option, gross profit, operating profit or other suitable measurements of value for an option. Thus, an objective function in various forms may be configured to compute a difference value between a selected profit value and cost value. One particular example objective function is discussed below in relation to FIG. 4 and additional details regarding suitable algorithms and objective functions are described in a section below titled “Online Resource Allocation Algorithm Implementation Details.”

An option is selected to allocate to the request based on the evaluation of the differences between profits and costs (block 308). In one example, an option that maximizes the profit or revenue is selected. This may be computed as the maximum of profit minus cost or conversely as the minimum of cost minus profit.

Resources corresponding to the selected option are allocated to the request (block 310). The particular resources 114 corresponding to the selected option may be provided to or reserved for the resource consumer 120 that submitted the request. The resources 114 that are consumed are then taken out of the pool of available resources. It should be noted that an amount of a particular resource consumed by a given request may be the full or partial quantity/capacity of the resource. Thus, a particular resource may be used completely for one request or divided across multiple requests in different scenarios.

Shadow costs associated with each resource are updated based on the allocation (block 312). The shadow costs may be updated in the manner previously described to account for rates of consumption of different resources and/or remaining quantities/capacities of resources available from different sources. Thus, if 50% of the impressions for a given webpage are allocated to an ad request, the shadow cost of the remaining 50% of the impressions may be increased to account for the partial consumption of the resource. Additionally or alternatively, the shadow cost for impressions of another page that were not allocated to the ad request may be reduced accordingly relative to other impression sources.

A next request is received (block 314) and the process just described may be repeated (e.g., repeat block 302 to block 312), this time using the updated shadow costs for the allocation. In this way, shadow costs may be iteratively used and updated to allocate resources successively to online requests for resources 114 from a service provider 102.

FIG. 4 is a flow diagram that describes a procedure 400 for an example objective function that may be incorporated within an online resource allocation algorithm in accordance with one or more embodiments. For instance, the example objective function may be used in connection with the matching of block 204 of procedure 200 and/or the evaluation of block 306 in procedure 300.

A total cost for a current option is computed based upon shadow costs associated with corresponding resources (block 402). The total cost may be computed by summing the quantity of resource requested times respective shadow costs for each resource associated with an option as discussed earlier. If an option/request includes just one resource, the total cost will be the total cost for the one resource (e.g., shadow cost times quantity). In cases where multiple resources are involved, the total cost is the sum of the individual costs for the multiple resources.

Profit associated with using the current option to fulfill the request is ascertained (block 404). A suitable profit value associated with an option may be computed as previously discussed in relation to FIG. 3. Thereafter, the total cost is subtracted from the profit for the current option to calculate a profit margin for the option (block 406). Here, the allocation manager 115 may compute a profit margin as a difference between profit and cost.

A determination in made regarding whether there is another option to be evaluated (block 408). As long as additional options to be evaluated exist, the process just described (e.g., block 402 to block 408) repeats for the next option to compute a profit margin for each available option. When each option has been evaluated, the options are compared to identify an option having the highest calculated profit margin (block 410). Naturally, profit values may be compared on an ongoing basis as the values are calculated with the highest value being selected (e.g., surviving) after each one on one comparison. Additionally or alternatively, values may be computed for each option first and then the highest value or otherwise optimal value (e.g., max of profit minus cost or min of cost minus profit) is ascertained. This option may then be selected to service the current request. In addition, shadow costs may be updated as noted previously and subsequently a request may be handled using the updated shadow costs.

Having described example procedures involving online resource allocation algorithms, consider now specific implementation examples that can be employed with one or more embodiments described herein.

Online Resource Allocation Algorithm Implementation Details

Consider now a discussion of example algorithms and implementations that may be employed using the previously described devices and systems. Additional proofs and details regarding resource allocation algorithms and techniques described herein can be found in “Near Optimal Online Algorithms and Fast Approximation Algorithms for Resource Allocation Problems” by Nikhil Devanur, Kamal Jain, Balasubramanian Sivan, Chris Wilkens, In the 12th ACM Conference on Electronic Commerce, EC (2011), which is incorporated by reference herein in its entirety.

In particular, a resource allocation framework is first described. After this, applications of the described techniques to “adwords” problems involving allocation of impressions to advertisers are introduced. Then, a simplified “min-max” version of the resource allocation framework is discussed. Thereafter, a competitive online algorithm for the resource allocation framework with stochastic input is described.

Resource Allocation Framework

Consider the following framework of optimization problems. There are n resources, with resource i having a capacity of cᵢ. There are m requests and each request j can be satisfied by a vector xⱼ that is constrained to be in a polytope Pⱼ (the vector xⱼ is referred to as an option to satisfy a request, and the polytope Pⱼ is referred to as the set of options.) The vector xⱼ consumes a_{i,j}·xⱼ amount of resource i, and gives a profit of wⱼ·xⱼ. Note that a_{i,j}, wⱼ and xⱼ are all vectors. The objective is to maximize the total profit subject to the capacity constraints on the resources. The following liner program (LP) describes the problem:

$$max {\sum }_{j} {w}_{j} \cdot {x}_{j} such that ( s . t )$$

$$∀ i : {\sum }_{j} {a}_{ij} \cdot {x}_{j} \leq {c}_{i}$$

$$∀ j : {x}_{j} ∈ \{ {P}_{j} \}$$

Assume there is an oracle available that given a request j and a vector v returns the vector xⱼ that maximizes v·xⱼ among all vectors in Pⱼ. Let

$$γ = max ( {\{ \frac{{a}_{ij} \cdot {x}_{j}}{{c}_{i}} \}}_{i , j} ⋃ {\{ \frac{{w}_{j} \cdot {x}_{j}}{{W}^{*}} \}}_{j} ) ,$$

which in the case of the “Adwords” examples herein corresponds to the bid to budget ratio. Here W* is the optimal offline objective to the distribution instance, that is defined below.

The canonical case is where each Pⱼ is a unit simplex in R^{K}, i.e., Pⱼ={xⱼεR^{K}:Σₖx_{j,k}≦1}. This captures the case where there are K discrete options, each with a given profit and consumption, which encompasses most of the interesting applications such as those described below. The co-ordinates of the vectors a_{i,j} and wⱼ are denoted by a(i, j, k) and w_{j,k} respectively, i.e., the kth option consumes a(i, j, k) amount of resource i and gives a profit of w_{j,k}.

Online Algorithms with Stochastic Input

Consider now an online version of the resource allocation framework. Here requests arrive online, e.g., in random order one at a time. In particular, consider the i.i.d. (independent and identically distributed) model, where each request is drawn independently from a given distribution. The distribution is unknown to the algorithm. The algorithm knows m, the total number of requests. The competitive ratios established for resource allocation problems with bounded γ are with respect to an upper bound on the expected value of fractional optimal solution, namely, the fractional optimal solution of the distribution instance, defined below.

Consider the following distribution instance of the problem. It is an offline instance defined for any given distribution over requests and the total number of requests m. The capacities of the resources cᵢ in this instance are the same as in the original instance. Every request in the support of the distribution is also a request in this instance. Suppose request j occurs with probability pⱼ. The resource consumption of j in the distribution instance is given by mpⱼa_{i,j} for all i and the profit is mpⱼwⱼ. The intuition is that if the requests were drawn from this distribution then the expected number of times request j is seen is mpⱼ and this is represented in the distribution instance by scaling the consumption and the profit vectors by mpⱼ. To summarize, the distribution instance is as follows:

$$maximize {\sum }_{j in the support} {mp}_{j} {w}_{j} \cdot {x}_{j} s . t . \\ ∀ i : {\sum }_{j} {mp}_{j} {a}_{ij} \cdot {x}_{j} \leq {c}_{i}$$

$$∀ j : {x}_{j} ∈ {P}_{j}$$

In may be shown that the fractional optimal solution to the distribution instance is an upper bound on the expectation of OPT, where OPT is the offline fractional optimum of the actual sequence of requests. This is expressed in the following lemma:

Lemma:

OPT[Distribution Instance]≧E[OPT]

The average of optimal solutions for all possible sequences of requests should give a feasible solution to the distribution instance with a profit equal to E[OPT]. Thus, the optimal profit for the distribution instance could only be larger.

The competitive ratio of an algorithm in the i.i.d model is defined as the ratio of the expected profit of the algorithm to the fractional optimal profit for the distribution instance. The main result is that as γ tends to zero, the competitive ratio tends to 1. This is in fact approximately the optimal trade-off. In other words, the ratio of the actual profit attained to the best profit available (which may be computed after the fact) is very close to 1. This is reflected by the following theorems.

Theorem 2:

For any ε>0, an algorithm exists such that if

$$γ = O ( \frac{{ε}^{2}}{log ( \frac{n}{ε} )} )$$

then the competitive ratio of the algorithm is 1−O(ε).

Theorem 3:

There exist instances with

$$γ = \frac{{ε}^{2}}{log ( n )}$$

such that no algorithm can get a competitive ratio of 1−o(ε).

Also, the example algorithm(s) described herein works when the polytope Pⱼ is obtained as an LP relaxation of the actual problem. To be precise, suppose that the set of options that could be used to satisfy a given request corresponds to some set of vectors say Iⱼ. Let the polytope be an approximate relaxation of if for the profit vector wⱼ and for all xⱼεPⱼ, there is an oracle that returns a yⱼεIⱼ such that wⱼ·yⱼ≧αwⱼ·xⱼ and, for all i, aᵢⱼ·yⱼ≦aᵢⱼ·xⱼ. Given such an oracle, the algorithm achieves a competitive ratio of α−O(ε), which can be stated as follows:

Theorem 4: Given a resource allocation problem with an approximate relaxation, and for any ε>0 an algorithm exists such that if

$$γ = O ( \frac{{ε}^{2}}{log ( \frac{n}{ε} )} )$$

then the competitive ratio of the algorithm is α−O(ε).

Consider the problem in the resource allocation framework defined by the relaxation, that is request j can actually be satisfied by the polytope Pⱼ. The optimal solution to the relaxation is an upper bound on the optimal solution to the original problem. Now run the online algorithm described below on the relaxation, and when the algorithm picks a vector xⱼ to serve request j, use the rounding oracle to round it to a solution yⱼ and use this solution. Since the sequence of xⱼ's picked by the algorithm are within 1−O(ε) of the optimum for the relaxation, and for all j, wⱼ·yⱼ≧αwⱼ·xⱼ this algorithm is α(1−O(ε)) competitive.

In fact, these results hold for the following more general model, the adversarial stochastic input model. In each step, the adversary adaptively chooses a distribution from which the request in that step is drawn. The adversary is constrained to pick the distributions in one of the following two ways. In the first case, we assume that a target objective value OPT_{T} is given to the algorithm, and that the adversary is constrained to pick distributions such that the fractional optimum solution of each of the corresponding distribution instances is at least OPT_{T} (or at most OPT_{T} for minimization problems). The competitive ratio is defined with respect to OPT_{T}. In the second case, the target is not given, but the adversary is constrained to pick distributions so that the fractional optimum of each of the corresponding distribution instances is the same, which is the benchmark with respect to which the competitive ratio is defined. Note that while the i.i.d model can be reduced to the random permutation model, these generalizations are incomparable to the random permutation model as they allow the input to vary over time. Also the constraint that each of the distribution instances has a large optimum value distinguishes this from the worst-case model. This constraint in general implies that the distribution must contain sufficiently rich variety of requests in order for the corresponding distribution instance to have a high optimum. To truly simulate the worst-case model, in every step the adversary would chose a “deterministic distribution”, that is a distribution supported on a single request. Then the distribution instance will simply have m copies of this single request and hence will not have a high optimum. For instance, consider online bipartite b-matching where each resource is a node on one side of a bipartite graph with the capacity cᵢ denoting the number of nodes it can be matched to and the requests are nodes on the other side of the graph and can be matched to at most one node. A deterministic distribution in this case corresponds to a single online node and if that node is repeated m times then the optimum for that instance is just the weighted (by cᵢ) degree of that node. If the adversary only picks such deterministic distributions then the adversary is constrained to pick nodes of very high degree thus making it easy for the algorithm to match them.

The “Adwords” Problem

In the i.i.d Adwords problem, there are n bidders, and each bidder i has a daily budget of Bᵢ dollars. Keywords arrive online with keyword j having an (unknown) probability pⱼ of arriving in any given step. For every keyword j, each bidder submits a bid, bᵢⱼ, which is the profit obtained by the algorithm on allocating keyword j to bidder i. The objective is to maximize the profit, subject to the constraint that no bidder is charged more than his budget. Here, the resources are the daily budgets of the bidders, the requests are the keywords, and the options are once again the bidders. The amount of resource consumed and the profit are both bᵢⱼ.

Min-Max Algorithm

Given the foregoing, consider now a slightly simplified version of the general online resource allocation problem, which is referred to as the min-max problem. In this problem, m requests arrive online, and each of them must be served. As a simplification, there is no profit to consider. The objective is to minimize the maximum fraction of any resource consumed. The following LP describes the problem.

$$mimimize λ s . t . \\ ∀ i , {\sum }_{j , k} a ( i , j , k ) {x}_{j , k} \leq λ {c}_{i}$$

$$∀ j , {\sum }_{k} {x}_{j , k} = 1$$

$$∀ j , k , {x}_{j , k} \geq 0$$

Here, λ is the maximum fraction of a resource that is consumed. Assume that the requests arrive according to the i.i.d model (e.g., an unknown distribution) and the algorithm proceeds in steps. Let λ* denote the fractional optimal objective value of the distribution instance of this problem. Let Xᵢ^{t} be a random variable indicating the amount of resource i consumed during step t, that is, Xᵢ^{t}=a(i,j,k) if in step t, request j was chosen and was served using option k. Let Sᵢ^{T}=Σₜ₌₁^{T}Xᵢ^{t} be the total amount of resource i consumed in the first T steps. Let

$$γ = {max}_{i , j , k} \{ \frac{a ( i , j , k )}{{c}_{i}} \} ,$$

which implies that for all i, j and k, a(i,j,k)≦γcᵢ. Let φ=i^{t}=(1+ε)^{S}^{ᵢ}^{^{y}}^{/γc}^{ᵢ}. For the sake of convenience, let Sᵢ⁰=1 and φᵢ⁰=0 for all i. The resulting algorithm for the min-max problem just defined is as follows:

ALG Min-Max:

In step t+1, on receiving request j, use option:

$${argmin}_{k} \{ {Σ}_{i} \frac{a ( i , j , k ) {φ}_{i}^{t}}{{c}_{i}} \} .$$

Lemma:

For any εε[0,1], the algorithm ALG Min-max described above approximates λ* within a factor of (1+ε) with a probability at least 1δ, where

$$δ = n . exp ( \frac{- ελ *}{4 γ} ) .$$

In the above min-max algorithm, a(i,j,k) represents the amount of a particular resource i that is consumed if option k is used for a request j and φᵢ^{t} represents the shadow cost 116 associated with that resource i at time t. In this case φᵢ^{t} is the total cost for the resource and cᵢ is the total capacity of the resource. Accordingly, the unit cost is φᵢ^{t}/cᵢ. Note that the shadow cost 116 at time t is set as a function of the amount of resource already consumed Sᵢ^{t} using tuning parameters ε and γ (e.g., φᵢ^{t}=(1+ε)^{S}^{ᵢ}^{^{y}}^{/γc}^{ᵢ}). The tuning parameters may be globally set to enable selective adjustments to be made to the algorithm. The fraction

$$\frac{a ( i , j , k ) {φ}_{i}^{t}}{{c}_{i}}$$

therefore represents the total cost of using option k to serve the request j. This fractional evaluation may be considered the objective function that is optimized by the example min-max algorithm. Accordingly, the min-max algorithm operates to return/select an option using the objective function (based on shadow costs) that minimizes the maximum fraction of any resources consumed for the selected option.

Online Algorithm with Stochastic Input

In this section, a suitable algorithm for the general resource allocation problem with profit being considered is described. Generally speaking the algorithm makes use of an objective function that evaluates a difference between profits and cost as discussed in relation to the example procedures of FIGS. 2-4 above. Once again, the general resource allocation problem can be expressed as an LP as follows:

$$maximize {\sum }_{j , k} {w}_{j , k} {x}_{j , k} s . t . \\ ∀ i {\sum }_{j , k} a ( i , j , k ) {x}_{j , k} \leq {c}_{i}$$

$$∀ j , {\sum }_{k} {x}_{j , k} \leq 1$$

$$∀ j , k , {x}_{j , k} \geq 0$$

The LP is constructed to maximize the profit w_{j,k}. The following example algorithm solves the LP and computes increasingly better estimates of the objective value by computing the optimal solution for the observed requests, and using it to guide future allocations. The algorithm achieves a competitive ratio of 1−O(ε). In this example, the number of requests m is known in advance. The example algorithm is described in table 1 just below:

TABLE 1
Algorithm for stochastic online resource allocation

| | |
|---|---|
| 1: | Initialize t₀:t₀ ← [εm] |
| 2: | for r = 0 to l − 1 do |
| 3: | for t = tᵣ + 1 to tᵣ₊₁ do |
| 4: | if t = tᵣ + 1 then |
| 5: | If the incoming request is j, use the following option k: |
| | $arg {min}_{k} \{ \begin{matrix}\frac{{ε}_{c} ( r ) / γ}{( 1 + \frac{{ε}_{c} ( r )}{γ m} )} {\sum }_{i} {φ}_{i}^{init} ( r ) \frac{a ( i , j , k )}{{c}_{i}} - \\ \frac{{ε}_{0} ( r ) / {w}_{max}}{( 1 - \frac{{ε}_{0} ( r ) Z ( r )}{{w}_{max} m} )} {φ}_{obj}^{init} ( r ) {w}_{j , k}\end{matrix} \}$ |
| 6: | For all i, Sᵢ^{t}(r) = Xᵢ^{t}, and V^{t} (r) = Y^{t}, |
| 7: | else |
| 8: | If the incoming request is j, use the following option k: |
| | $arg {min}_{k} \{ \begin{matrix}\frac{{ε}_{c} ( r ) / γ}{( 1 + \frac{{ε}_{c} ( r )}{γ m} )} {\sum }_{i} {φ}_{i}^{t - 1} ( r ) \frac{a ( i , j , k )}{{c}_{i}} - \\ \frac{{ε}_{0} ( r ) / {w}_{max}}{( 1 - \frac{{ε}_{0} ( r ) Z ( r )}{{w}_{max} m} )} {φ}_{obj}^{t - 1} ( r ) {w}_{j , k}\end{matrix} \}$ |
| 9: | For all i, Sᵢ^{t}(r) = Sᵢ^{t-1}(r) + Xᵢ^{t}, and V^{t} (r) = V^{t+1}(r) + Y^{t}, |
| 10: | end if |
| 11: | end for |
| 12: | end for |

In general the example algorithm above uses an objective function that effectively operates to minimizes costs for an option minus profit for the option where shadow costs are again represented by φ and the profit is denoted using w. In line 8 for instance, the factor

$${φ}_{i}^{t - 1} ( r ) \frac{a ( i , j , k , )}{{c}_{i}}$$

represents the total cost and the factor w_{j,k} represents the associated profit for an option. These values are multiplied by various tuning parameters that provide control over the output/efficiency of algorithm and/or scaling factors used to normalize/balance the cost and profit terms.

In operation, the algorithm proceeds in different stages. Initially, a sampling of requests εm may be evaluated for computational purposes without actually be served. This enables an estimate of the initial costs and/or profits to use for initialization of the algorithm. The evaluation of the objective function returns profit margin values that may be compared for different available options for a given request, as discussed previously. After each stage, the shadow costs are updated accordingly based on the allocation that occurred in the preceding stages. This is reflected in that the cost used for a stage at time t is φᵢ^{t-1}(r), e.g., the cost computed at time t−1.

Having described example implementation details regarding online resource allocation algorithms, consider now an example system that can be employed to implement aspects of the described techniques.

Example System

FIG. 5 illustrates an example system generally at 500 that includes an example computing device 502 that is representative of one or more such computing systems and/or devices that may implement the various embodiments described above. The computing device 502 may be, for example, a server of a service provider 102, a device associated with a client 128 (e.g., a client device), a system on-chip, and/or any other suitable computing device or computing system.

The example computing device 502 includes one or more processors 504 or processing units, one or more computer-readable media 506 which may include one or more memory and/or storage components 508, one or more input/output (I/O) interfaces 510 for input/output (I/O) devices, and a bus 512 that allows the various components and devices to communicate one to another. Computer-readable media 506 and/or one or more I/O devices may be included as part of, or alternatively may be coupled to, the computing device 502. The bus 512 represents one or more of several types of bus structures, including a memory bus or memory controller, a peripheral bus, an accelerated graphics port, and a processor or local bus using any of a variety of bus architectures. The bus 512 may include wired and/or wireless buses.

The one or more processors 504 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The memory/storage component 508 represents memory/storage capacity associated with one or more computer-readable media. The memory/storage component 508 may include volatile media (such as random access memory (RAM)) and/or nonvolatile media (such as read only memory (ROM), Flash memory, optical disks, magnetic disks, and so forth). The memory/storage component 508 may include fixed media (e.g., RAM, ROM, a fixed hard drive, etc.) as well as removable media (e.g., a Flash memory drive, a removable hard drive, an optical disk, and so forth).

Input/output interface(s) 510 allow a user to enter commands and information to computing device 502, and also allow information to be presented to the user and/or other components or devices using various input/output devices. Examples of input devices include a keyboard, a touchscreen display, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, hardware elements (e.g., fixed logic) of an integrated circuit or chip, or other storage device, tangible media, or article of manufacture suitable to store the desired information and which may be accessed by a computer.

“Communication media” may refer to a signal bearing medium that is configured to transmit instructions to the hardware of the computing device, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the resource manager 112, resources 114, allocation manager 115, operating system 110, applications 108 and other program modules, may be implemented as one or more instructions and/or logic embodied on some form of computer-readable media.

Accordingly, particular modules, functionality, components, and techniques described herein may be implemented in software, hardware, firmware and/or combinations thereof. The computing device 502 may be configured to implement particular instructions and/or functions corresponding to the software and/or hardware modules implemented on computer-readable media. The instructions and/or functions may be executable/operable by one or more articles of manufacture (for example, one or more computing devices 502 and/or processors 504) to implement techniques for online allocation algorithms, as well as other techniques. Such techniques include, but are not limited to, the example procedures described herein. Thus, computer-readable media may be configured to store or otherwise provide instructions that, when executed by one or more devices described herein, cause various techniques for online allocation algorithms.

### CONCLUSION

Although the invention has been described in language specific to structural features and/or methodological steps, it is to be understood that the invention defined in the appended claims is not necessarily limited to the specific features or steps described. Rather, the specific features and steps are disclosed as example forms of implementing the claimed invention.

1. A computer-implemented method comprising:
assigning shadow costs to resources available from a service provider;
matching resources to a resource request by evaluating multiple allocation options based in part upon shadow costs associated with corresponding resources;
updating the shadow costs associated with the resources based on the matching to reflect differences in rates for consumption of the resources; and
allocating resources to a subsequent resource request using the updated shadow costs.

2. The computer-implemented method of claim 1, wherein assigning the shadow costs comprises calculating cost per unit of each resource.

3. The computer-implemented method of claim 1, wherein evaluating multiple allocation options based in part upon shadow costs comprises evaluating a difference between profit and cost for the each of the one or more options using an objective function.

4. The computer-implemented method of claim 1, wherein the matching comprises selecting an option that maximizes a profit margin computed for each of the one or more options using the shadow costs.

5. The computer-implemented method of claim 4, wherein the profit margin for each particular option is computed as a difference between revenue generated by the option and total cost for the option determined by summing shadow cost times the amount of resource consumed for each resource corresponding to the particular option.

6. The computer-implemented method of claim 1, wherein assigning the shadow costs to the resources comprises sampling resource requests to obtain an initial estimate for the shadow costs.

7. The computer-implemented method of claim 1, wherein the matching comprises applying a resource allocation algorithm to evaluate an objective function based on the shadow costs that encodes a computational objective for allocation of the resources.

8. The computer-implemented method of claim 7, wherein the resource allocation algorithm is configured to select an option k for a request j as:
$${argmin}_{k} \{ \frac{{ε}_{c} ( r ) / γ}{( 1 + \frac{{ε}_{c} ( r )}{γ m} )} {Σ}_{i} {φ}_{i}^{init} ( r ) \frac{a ( i , j , k , )}{{c}_{i}} - \frac{{ε}_{0} ( r ) / {w}_{max}}{( 1 - \frac{{ε}_{0} ( r ) Z ( r )}{{w}_{max} m} )} {φ}_{obj}^{init} ( r ) {w}_{j , k} \} ;$$
for one or more initial requests; and as
$${argmin}_{k} \{ \frac{{ε}_{c} ( r ) / γ}{( 1 + \frac{{ε}_{c} ( r )}{γ m} )} {Σ}_{i} {φ}_{i}^{t - 1} \frac{a ( i , j , k , )}{{c}_{i}} - \frac{{ε}_{0} ( r ) / {w}_{max}}{( 1 - \frac{{ε}_{0} ( r ) Z ( r )}{{w}_{max} m} )} {φ}_{obj}^{t - 1} {w}_{j , k} \} ;$$
for one or more subsequent requests, wherein φᵢ^{init}(r) represents shadow cost for an option at the beginning of stage r, φᵢ^{t-1} represents updated shadow cost at time t, and w_{j,k} represents a profit value for using the option k for the request j.

9. One or more computer-readable storage media storing instructions that, when executed by one or more computing devices of a service provider, cause the one or more server devices to implement an allocation manager configured to:
obtain a request for resources available from a service provider;
identify one or more options of available resources to satisfy the request;
evaluate a difference between profit and the cost computed for each of the options using an objective function that accounts for shadow costs assigned to the resources corresponding to each of the options;
select an option to fulfill the request that maximizes profit margin based on the evaluation of the differences between profits and costs; and
allocate resources corresponding to the selected option to the request.

10. One or more computer-readable storage media of claim 9, wherein the allocation manager is further configured to update shadow costs associated with each resource based on the allocation of resources to the request.

11. One or more computer-readable storage media of claim 10, wherein updating the shadow costs associated with each resource based on the allocation comprises increasing the shadow cost corresponding to a resources as consumption of the resource increases.

12. One or more computer-readable storage media of claim 9, wherein the objective function identifies a particular option of the one or more options for which the cost subtracted from the profit is maximized.

13. One or more computer-readable storage media of claim 9, wherein the request for resources comprises an order from an advertiser for advertising impressions available from the service provider via webpages served to clients by the service provider.

14. One or more computer-readable storage media of claim 9, wherein the request for resources comprises a request from a client for online computing resources available from the service provider.

15. One or more computer-readable storage media of claim 9, wherein identifying one or more options of available resources comprises matching one or more request constraints specified by the request with the resources having associated resource constraints such that the request constraints and resource constraints are satisfied.

16. One or more computer-readable storage media of claim 9, wherein the objective function that accounts for shadow costs is configured to select an option k to satisfy a request j and has a form:
$${argmin}_{k} \{ \frac{{ε}_{c} ( r ) / γ}{( 1 + \frac{{ε}_{c} ( r )}{γ m} )} {Σ}_{i} {φ}_{i}^{t - 1} ( r ) \frac{a ( i , j , k , )}{{c}_{i}} - \frac{{ε}_{0} ( r ) / {w}_{max}}{( 1 - \frac{{ε}_{0} ( r ) Z ( r )}{{w}_{max} m} )} {φ}_{obj}^{t - 1} ( r ) {w}_{j , k} \} ,$$
wherein φᵢ^{t-1} represents shadow costs at time t, w_{j,k} represents a profit value for using the option k for the request j, a(i,j,k,) is an amount of resource i consumed if option k is used for the request j, cᵢ is the capacity of the resource i, and the terms
$$\frac{{ε}_{c} ( r ) / γ}{( 1 + \frac{{ε}_{c} ( r )}{γ m} )} and \frac{{ε}_{0} ( r ) / {w}_{max}}{( 1 - \frac{{ε}_{0} ( r ) Z ( r )}{{w}_{max} m} )} {φ}_{obj}^{t}$$
are configurable parameters for tuning the algorithm and scaling cost and profit terms.

17. A computing system comprising:
one or more processors; and
computer readable storage media having one or more modules stored thereon, that, when executed via the one or more processors, cause the computing system to perform acts including:
computing a total cost for a current option to allocate resources from a service provider to a request based on shadow costs associated with resources corresponding to the current option;
ascertaining profit associated with using the current option to fulfill the request;
subtracting the computed total cost from the ascertained profit to calculate a profit margin for the current option;
repeating the computing, ascertaining, and subtracting for at least one other available option to allocate resources from the service provider to the request to determine a profit margin for each available option; and
compare the profit margins determined for each of the available options to identify an option having the highest calculated profit margin.

18. The computer system of claim 17, further comprising:
allocating resources corresponding to the identified option to the request;
updating the shadow costs to reflect differences in rates of consumption for corresponding resources; and
using the updated shadow costs to evaluate options for allocation of resources to a subsequent request.

19. The computer system of claim 17, wherein the computing, ascertaining, and subtracting occur through application of an resource allocation algorithm configured to evaluate an objective function based on the shadow costs to compute the profit margin and select an option that maximizes the profit margin.

20. The computer system of claim 17, wherein the request comprises an order from an advertiser for impressions to enable the advertiser to place advertisements for presentation to clients in conjunction with resources provided by a service provider to clients in webpages.

21. One or more computer-readable storage media storing instructions that, when executed by one or more computing devices of a service provider, cause the one or more server devices to perform operations comprising:
assigning shadow costs to resources available from a service provider;
obtaining a resource request for resources available from the service provider
matching resources to the resource request by evaluating multiple allocation options based in part upon shadow costs associated with corresponding resources;
updating the shadow costs associated with the resources based on the matching to reflect differences in rates for consumption of the resources; and
allocating resources to a subsequent resource request using the updated shadow costs.

22. One or more computer-readable storage media of claim 21, wherein assigning the shadow costs comprises calculating cost per unit of each resource.

23. The computer-implemented method of claim 1, wherein evaluating multiple allocation options based in part upon shadow costs comprises evaluating a difference between profit and cost for the each of the one or more options using an objective function.

24. One or more computer-readable storage media of claim 23, wherein the objective function is configured to select an option k to satisfy a request j and has a form:
$${argmin}_{k} \{ \frac{{ε}_{c} ( r ) / γ}{( 1 + \frac{{ε}_{c} ( r )}{γ m} )} {Σ}_{i} {φ}_{i}^{t - 1} ( r ) \frac{a ( i , j , k , )}{{c}_{i}} - \frac{{ε}_{0} ( r ) / {w}_{max}}{( 1 - \frac{{ε}_{0} ( r ) Z ( r )}{{w}_{max} m} )} {φ}_{obj}^{t - 1} ( r ) {w}_{j , k} \} ,$$
wherein φᵢ^{t-1} represents shadow costs at time t, w_{j,k} represents a profit value for using the option k for the request j, a(i,j,k,) is an amount of resource i consumed if option k is used for the request j, cᵢ is the capacity of the resource i, and the terms
$$\frac{{ε}_{c} ( r ) / γ}{( 1 + \frac{{ε}_{c} ( r )}{γ m} )} and \frac{{ε}_{0} ( r ) / {w}_{max}}{( 1 - \frac{{ε}_{0} ( r ) Z ( r )}{{w}_{max} m} )} {φ}_{obj}^{t}$$
are configurable parameters for tuning the algorithm and scaling cost and profit terms.

25. One or more computer-readable storage media of claim 21, wherein the matching comprises selecting an option that maximizes a profit margin computed for each of the one or more options using the shadow costs.

26. One or more computer-readable storage media of claim 21, wherein the profit margin for each particular option is computed as a difference between revenue generated by the option and total cost for the option determined by summing shadow cost times the amount of resource consumed for each resource corresponding to the particular option.

27. One or more computer-readable storage media of claim 21, wherein assigning the shadow costs to the resources comprises sampling resource requests to obtain an initial estimate for the shadow costs.

28. One or more computer-readable storage media of claim 21, wherein the matching comprises applying a resource allocation algorithm to evaluate an objective function based on the shadow costs that encodes a computational objective for allocation of the resources.

29. The computer-implemented method of claim 28, wherein the resource allocation algorithm is configured to select an option k for a request j as:
$${argmin}_{k} \{ \frac{{ε}_{c} ( r ) / γ}{( 1 + \frac{{ε}_{c} ( r )}{γ m} )} {Σ}_{i} {φ}_{i}^{init} ( r ) \frac{a ( i , j , k , )}{{c}_{i}} - \frac{{ε}_{0} ( r ) / {w}_{max}}{( 1 - \frac{{ε}_{0} ( r ) Z ( r )}{{w}_{max} m} )} {φ}_{obj}^{init} ( r ) {w}_{j , k} \} ;$$
for one or more initial requests; and as
$${argmin}_{k} \{ \frac{{ε}_{c} ( r ) / γ}{( 1 + \frac{{ε}_{c} ( r )}{γ m} )} {Σ}_{i} {φ}_{i}^{t - 1} \frac{a ( i , j , k , )}{{c}_{i}} - \frac{{ε}_{0} ( r ) / {w}_{max}}{( 1 - \frac{{ε}_{0} ( r ) Z ( r )}{{w}_{max} m} )} {φ}_{obj}^{t - 1} {w}_{j , k} \} ;$$
for one or more subsequent requests, wherein φᵢ^{init}(r) represents shadow cost for an option at the beginning of stage r, φᵢ^{t-1} represents updated shadow cost at time t, and w_{j,k} represents a profit value for using the option k for the request j.

30. A computing system comprising:
one or more processors; and
computer readable media having one or more modules stored thereon, that, when executed via the one or more processors, cause the computing system to perform acts including:
computing shadow costs associated with resources available from a service provider;
evaluating using an objective function multiple resource allocation options for a resource request based in part upon shadow costs associated with corresponding resources;
matching resources to the resource request according to the evaluating;
updating the shadow costs associated with the resources based on the matching to reflect differences in rates for consumption of the resources; and
allocating resources to a subsequent resource request using the updated shadow costs.

31. The computing system of claim 30, wherein the evaluating comprises computing a profit margin for each particular option as a difference between revenue generated by the option and total cost for the option determined by summing shadow cost times the amount of resource consumed for each resource corresponding to the particular option.

32. The computing system of claim 30, wherein the objective function is configured to select an option k to satisfy a request j and has a form:
$${argmin}_{k} \{ \frac{{ε}_{c} ( r ) / γ}{( 1 + \frac{{ε}_{c} ( r )}{γ m} )} {Σ}_{i} {φ}_{i}^{t - 1} ( r ) \frac{a ( i , j , k , )}{{c}_{i}} - \frac{{ε}_{0} ( r ) / {w}_{max}}{( 1 - \frac{{ε}_{0} ( r ) Z ( r )}{{w}_{max} m} )} {φ}_{obj}^{t - 1} ( r ) {w}_{j , k} \} ,$$
wherein φᵢ^{t-1} represents shadow costs at time t, w_{j,k} represents a profit value for using the option k for the request j, a(i,j,k,) is an amount of resource i consumed if option k is used for the request j, cᵢ is the capacity of the resource i, and the terms
$$\frac{{ε}_{c} ( r ) / γ}{( 1 + \frac{{ε}_{c} ( r )}{γ m} )} and \frac{{ε}_{0} ( r ) / {w}_{max}}{( 1 - \frac{{ε}_{0} ( r ) Z ( r )}{{w}_{max} m} )} {φ}_{obj}^{t}$$
are configurable parameters for tuning the algorithm and scaling cost and profit terms.
